(19) United States
(12) Patent Application Publication
(10) Pub. No.: US 2017/0175693 A1
(43) Pub. Date: Jun. 22, 2017

(54) A FUEL INJECTOR FLEXIBLE FOR SINGLE AND DUAL FUEL INJECTION

(71) Applicants: Deyang HOU, Sugar Land, TX (US); QuantLogic Corporation, Sugar Land, TX (US)

(72) Inventor: Deyang Hou, Sugar Land, TX (US)

(73) Assignees: QuantLogic Corporation, Sugar Land, TX (US); Deyang Hou, Sugar Land, TX (US)

(21) Appl. No.: 15/129,807

(22) PCT Filed: Mar. 28, 2015
(86) PCT No.: PCT/US15/23205

§ 371 Date: Sep. 27, 2016

Related U.S. Application Data
(60) Provisional application No. 61/972,207, filed on Mar. 28, 2014.

(51) Int. Cl. F02M 43/04; F02M 61/10; B05B 1/32

(52) U.S. Cl. CPC F02M 43/04; B05B 1/32; F02M 61/10; F02M 2200/46; F02M 47/027

(57) ABSTRACT

A variable orifice fuel injector has an inward opening needle valve and an outward opening needle valve and has means to directly inject two types of fuels independently and collectively. Both needle valves are fully contained in a nozzle body, with a co-axial smaller needle valve at least partially being contained in a larger needle valve.

### BACKGROUND OF THE INVENTION

This application claims the priority of U.S. Provisional Application 61/972207, filed on Mar. 28, 2014.

### CROSS REFERENCE TO RELATED APPLICATION

This application is the National Stage Entry of PCT/US2015/023205.

### TECHNICAL FIELDS

This invention is related to a fuel injector and an internal combustion engine. More specifically, this invention disclosed a fuel injector which can independently or collectively inject two types of fuels differentiated by at least one parameter of pressure, molecular structure or thermodynamic phases, and an engine using at least one such fuel injector, which can be a spark—ignition engine or a compression-ignition engine.

Description of the Related Art—The combustion process in a conventional direct injection Diesel engine is characterized by diffusion combustion with a fixed-spray-angle multi-hole fuel injector. Due to its intrinsic non-homogeneous characteristics of fuel-air mixture formation, it is often contradictory to simultaneously reduce soot and NOx formation in a conventional diesel engine. Over last two decades, significant progress has been made for Diesel engine combustion. Progress has been made in recent years for advanced combustion modes, such as Homogeneous-Charge Compression-Ignition (HCCI) combustion, reactivity controlled compression ignition (RCCI) and Premixed Charge Compression Ignition (PCCI). However, many issues remain to be solved to control the ignition timing, the duration of combustion, the rate of combustion for various load and speed conditions. It is desirable to have a fuel injector which can directly inject two fuels differentiated by at least one parameter of injection pressure, molecular structure, and thermodynamics phases. Further, it is desirable to inject two types of fuels at different spray angles tailored for different injection timings at different engine load and speed conditions.

However, even though many inventions have been disclosed for dual fuel injectors and injectors with variable orifices, issues related to manufacture complexity and fuel leaking have prevented many inventions from being mass production viable. These issues are especially true for common rail injectors with compact nozzles, where arrangement of complex fuel passages becomes a challenging task. Furthermore, few of previous disclosed arts can offer the injection capability of selectively and collectively direct inject different fuels without interfering with each other between the operations of injecting different fuels. Thus, previous arts demands significant control complexity, especially for synchronizing the dual needle operations normally used for dual fuel injections.

### SUMMARY OF THE INVENTION

It is our goals of this invention to at least solve some of the major issues facing previous arts. More specifically, this invention offers co-axial needle valve designs which can operate both selectively and collectively to give the freedom to inject either a single fuel, either fuel of two supplied fuels, or a combination of two supplied fuels, on demand based on engine operation conditions and the need for optimizing combustion. This work can be considered as an extension of our previous work disclosed in PCT/US11/56002.

The invention disclosed a fuel injector which has the capability to quickly switch fuel spray pattern with different spray angles in a same engine power cycle, and is capable of injecting two different fuels in the same engine power cycle with multiple injections.

### BRIEF DESCRIPTION OF THE DRAWINGS

FIG. 1 is a fragmentary sectional view of a first exemplary embodiment of an injector of the invention with only key components marked;

FIG. 2 is same as FIG. 1 except there are only a set of fuel injection outlets on nozzle body;

FIG. 3 is the same as FIG. 1 except with detailed notations for key components, key fuel passages, key surfaces, and key pressure control chambers marked.

FIG. 4 is another fragmentary sectional view of a second exemplary embodiment of an injector of the invention with only key components marked;

FIG. 5 is the same as FIG. 4 except with detailed notations for key components, key fuel passages, key surfaces, and key pressure control chambers marked.

FIG. 6 is an illustration of the injection spray patterns along with injection timings for an internal combustion engine using the fuel injector as in FIG. 1 and FIG. 3;

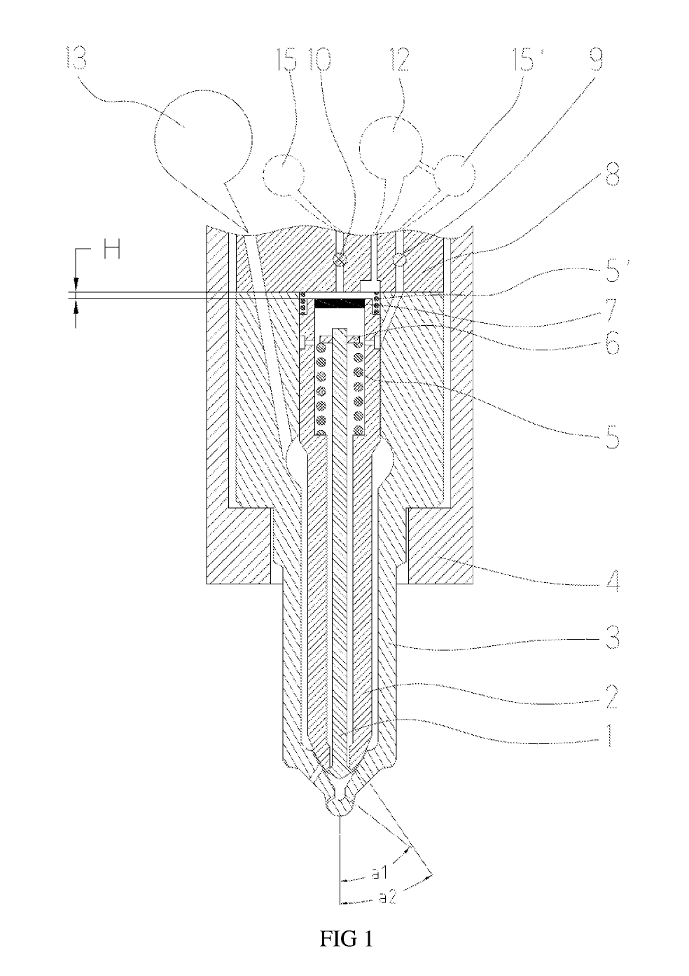

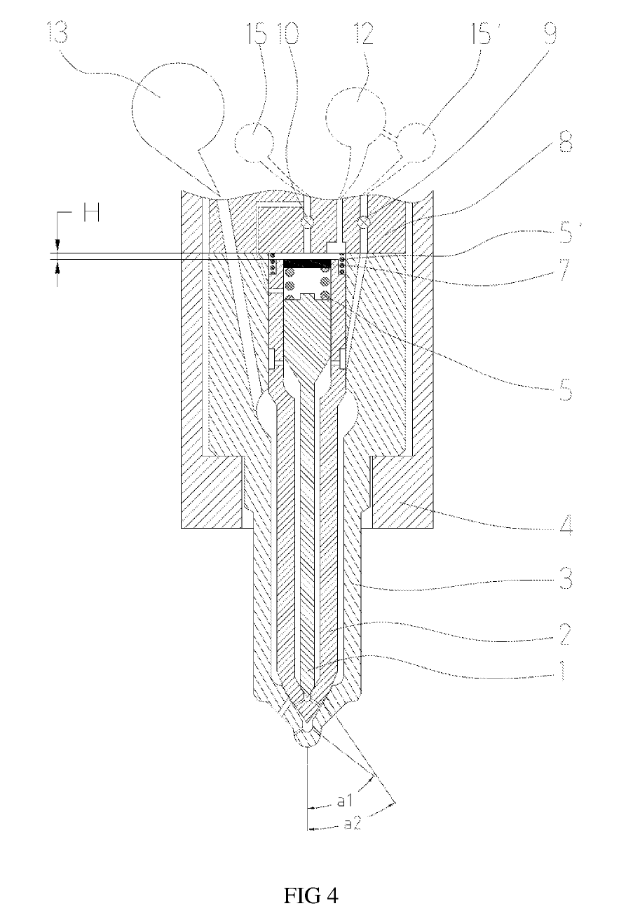

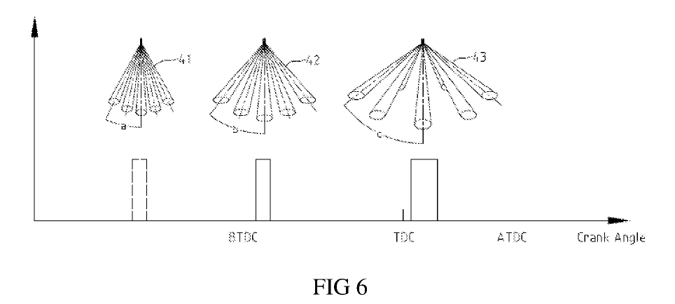

Except specifically specified, in all the figures:
In FIG. 1˜3: 1—inner outward opening needle valve; 101—inner needle valve head, 121—inner fuel injection outlets formed by lifting needle valve 1, 102—head surface of 1, 103—seal surface of inner needle valve, 104—needle guide for 1, 122—fuel passage, 124—sliding surface, 125—pressure control chamber, 161—tightly fitted surface between 1 and 6,
In FIG. 4˜5: 1—inner inward opening needle valve; 101—inner needle valve, 121—the sealing surface formed by pressing needle 1 into seating position on needle valve 2, 121′ (not shown)—seal surface of inner needle valve, 125—pressure or venting chamber;
2—outer inward opening needle valve; 201—sealing surface of 2, 202—sealing surface on 2 for needle valve 1, 203—needle guide of 2 (not shown), 204—thrusting surface of 2, 205—fuel inlet for pressure chamber, 206—top surface of 2, 207—fuel venting outlet, 208—inner fuel injection outlets, 231—contact sealing surface between needle 2 and nozzle body 3 when needle valve 2 is at seating position, 231′—fuel passage under needle seat of 2 when it is lifted, 232—fuel passage, 233—pressure chamber, 122—fuel passage, 123—sectional sliding matched surface between 1 and 2;
3—nozzle body; 301—fuel injection outlets; 302—inner conical surface on nozzle body; 303—high pressure fuel passage leading fuel to pressure chamber 233, 304—sliding surface, 305—fuel passage leading fuel from fuel reservoir 15′ to pressure control chamber 125, 306—nozzle large end, 307—inner bore of 3, 308—fuel channel, 381, 382—pressure chambers;
4—injector body cap; 341—contact surface between 3 and 4;
5, 5′—spring which urges needle valves 1 and 2 into seating positions;
6—clip ring to hold needle valve 1;
7—tight seal cap for pressure control chamber for needle valve 2;
8—valve block which holds valves and fuel passages, 801—fuel passage to valve 9, 802—pressure passage to venting valve 10, 803—high pressure passage; 804—bottom of valve block 8, 805, 806—fuel passages;
9—flow control valve;
10—venting control valve, which can be a single valve or a control valve having a throttling valve below it connecting to 802;
12—high pressure fuel reservoir;
13—high pressure fuel reservoir;
12 and 13 can be one such as common rail holding one type of fuel, or two common rails for different fuels or for one fuel with different pressures;
15—low pressure fuel sink;
a1—half multiple jet spray angle for fuel injection outlets 301;
a2—half multiple jet spray angle for fuel injection outlets 309;

### DETAILED DESCRIPTION OF THE PREFERRED EMBODIMENTS

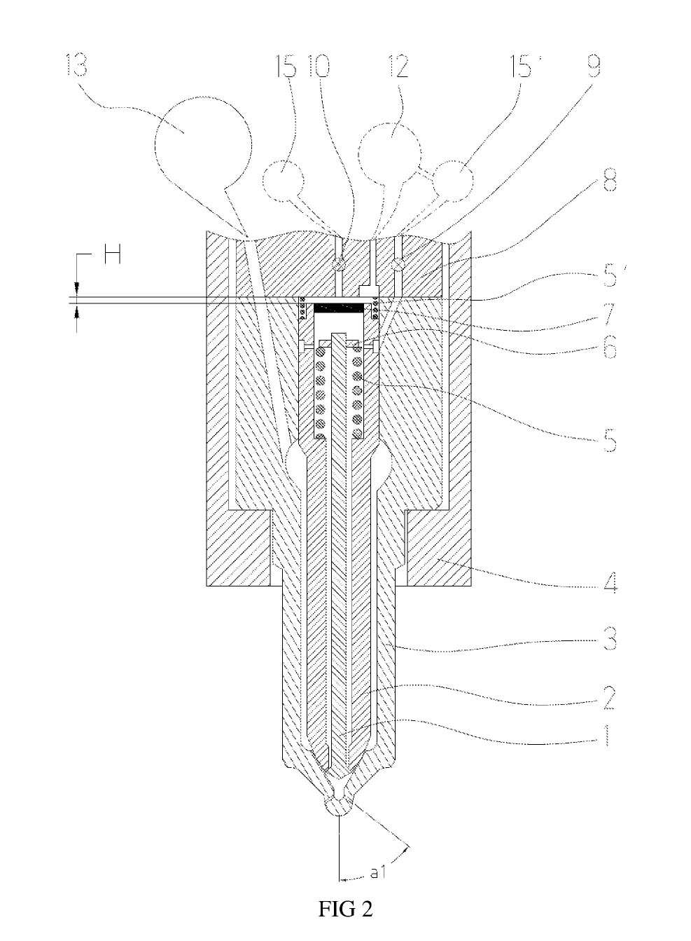

A first embodiment was shown in FIG. 1 to FIG. 3. FIGS. 1˜2 show the State I when both the outward opening valve 1 and inward opening valve 2 is at seating position, no fuel is injected. While at State I, valve 10 is closed, valve 9 is closed.

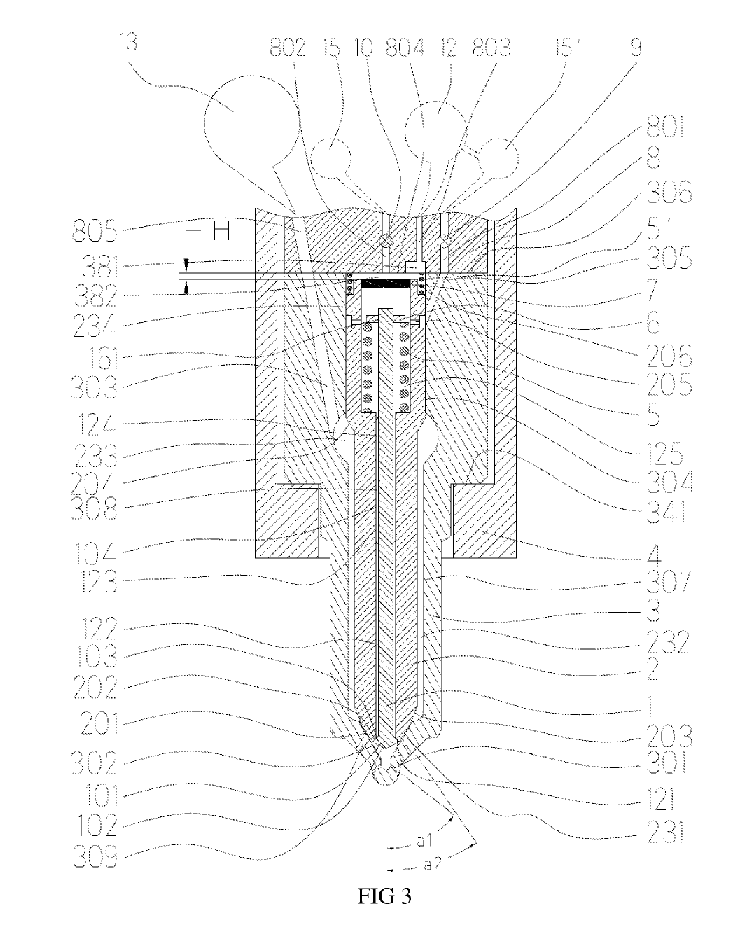

The design in FIG. 3 is FIG. 1 except it has only one group of fuel injection outlets (301).

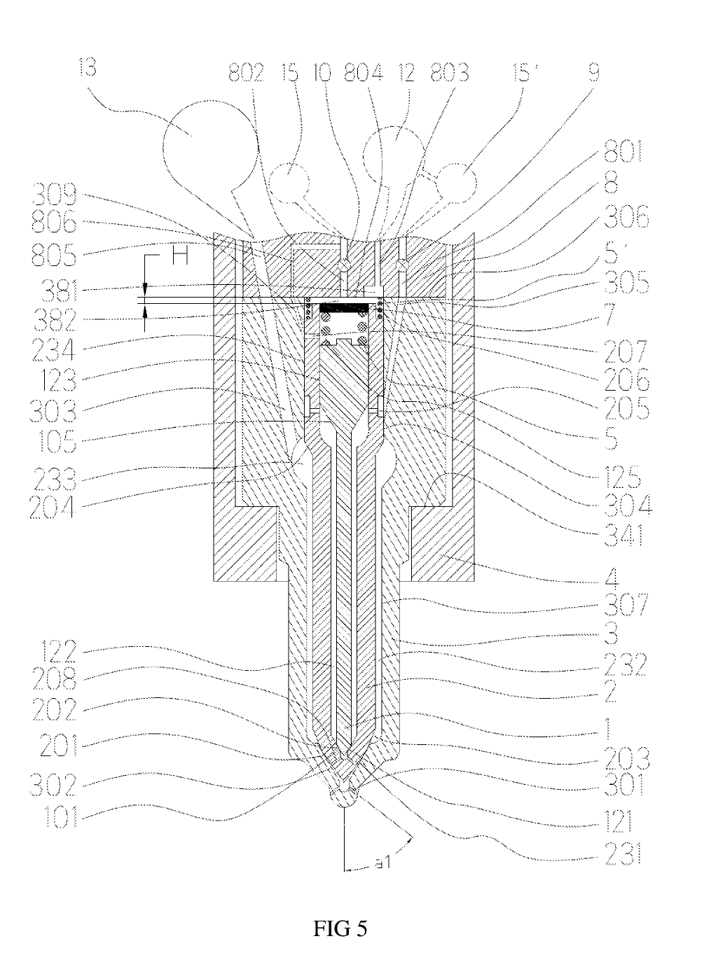

A first embodiment was shown in FIG. 4 to FIG. 5. FIGS. 4˜5 show the State I when both the inner inward opening valve 1 and outer inward opening valve 2 is at seating position, no fuel is injected. While at State I, valve 10 is closed, valve 9 is closed.

We have illustrated one embodiment here. For those skilled in the art, it is easy to give alternatives based on the same operation mechanism. The embodiment illustrated here should be considered as an example without limiting the scope of the invention. Other embodiments with the same key characteristics are considered under the scope of this invention. For example, the first fuel and second fuel are the same fuel, thus the injector becomes a single fuel injector. Following features are considered as the key characteristics of the invention.
STATEMENT A: Referring to FIG. 3, a variable orifice fuel injector comprising:
   (i) a nozzle body (3) comprising passages for fuels, an inner cylindrical bore (307) for receiving two longitudinally displaceable coaxial needle valves (1, 2), one is outward opening needle valve (1) and another is inward opening needle valve (2), at least one group of fuel injection outlets (301, 309) in the nozzle body, at least one spring (5, 5′) which urges the needle valves (1,2) into biased seating positions to block fuels, and a valve block (8) to hold control valves and having fuel inlets which can be connected to two pressured fuel reservoirs (12, 13), pressure control chambers (382, 125) which can press and release needle valves through connecting to pressurized and de-pressurized fuels, and
   (ii) the outward opening needle valve (1), has an opening position which is moving away relative to the nozzle body large end (306) to inject fuel from at least one pressurized fuel reservoir (15′) through an annular fuel outlet (121) and fuel injection outlets (301), and a seating position to block fuel flow, and
   (iii) the inward opening needle valve (2), which is fully contained in the nozzle body (3), has an opening position by moving toward the nozzle body large end (306) to connects at least one pressurized fuel reservoir (13) and fuel injection outlets (309, 301) to inject fuel, wherein the lifting of the inward opening needle valve (2) is independent of the position of the outward opening needle valve (1), and, has a seating position being in contact with the sealing surface of nozzle body to block fuel flow from fuel inlets to fuel injection outlets (309), the sealing surface (201) at seating position is up stream of injection outlets (309), and
   (iv) the outward opening needle valve (1) is partially contained in the inward opening needle valve (2) and has a biased siting position on the inward opening needle valve (2), wherein the lifting of outward opening needle valve (1) is independent of the position of the inward opening needle valve (2); Wherein, the variable orifice fuel injector has means to inject different fuels independently and collectively.

A fuel injector of STATEMENT A, wherein it is comprising at least two control valves (9, 10) to block or connect at least one type of fuel from high pressure fuel reservoirs (13, 12, 15′) to low pressure fuel sink (15) to produce the lifting and closing forces on the inward opening and outward opening needle valves (1, 2) through generating pressure differences in pressure control chambers (382, 125).

Note that in the exemplary illustration FIG. 3, high pressure fuel reservoirs 12 and 15′ are actually connected to a single fuel reservoir. Fuel reservoir 13 and 12 can hold two types of fuels differentiated by at least one parameter of molecular structure, pressure and thermodynamic phases. In the case of the fuels in two fuel reservoirs are only differentiated by pressure, it can simply be considered as a single fuel injection at two pressure levels. In this scenario, the fuel injector is simply becomes a single fuel injector with variable orifice for different injection spray angles.

A fuel injector of STATEMENT A, wherein the outward opening needle valve (1) is longitudinally displaceable and partially contained within the inward opening needle valve (2) and guided by the needle guide (104) which is longitudinally displaceable in the inner bore of the inward opening valve (2), wherein the outward needle valve (1) is at a biased closing position, or at an opening position through pushing the top surface of the outward opening needle valve with pulse pressured fuel to force the outward needle valve (1) moving outward to inject fuel through one group of fuel injection outlets (301).

A fuel injector of STATEMENT A, wherein the inward opening needle valve (2) has a cylindrical space to hold spring (5), the outward opening needle valve (1) and a clip (6), wherein the inward opening needle valve (2) is further comprising fuel passages (122), and a seal cap (7) to define the needle lift, and thrusting surfaces (203, 204) and pressure control chamber (382) to generating lifting force to lift the needle to inject fuel in multiple jets through fuel outlets (301, 309);

A fuel injector of STATEMENT A, wherein the half fuel spray angle for one group of fuel injection outlets (al) and half spray angle for another group of fuel injection outlets (a2) can be same or different, wherein with preferred embodiment such that a1 is greater than a2, wherein the individual fuel outlets can have the same or different flow area, even within the same group.

A fuel injector according to any of above configurations, wherein it has means to inject one type of fuel through fuel injection outlets (301) by lifting the outward opening needle valve (1) and inject another type of fuel through multiple jet fuel outlets (309) by lifting the inward opening needle valve (2) independently, wherein the injections of two types of fuels can be independently or simultaneously.

A fuel injector according to any of above configurations, wherein it has means to inject the same fuel with different pressures through fuel injection outlets (301) controlled by the outward opening needle valve (1) and another group of fuel outlets (309) controlled by the inward opening needle valve (2), preferably with low pressure fuel being supplied to the fuel injection outlets (309) with smaller spray angles and high pressure fuel being supplied to the multiple jet fuel outlets (301) with larger spray angles, wherein the pressurized fuels in fuel reservoirs are of same molecular structure.

Not that in all the above cases, the two groups of fuel injection outlets (301, 309) can be merged into a single group of fuel injection out lets with a spray angle being compromised for different injection timings.

An internal combustion engine using at least one fuel injector of any claim above, which can be a spark—ignition engine or a compression-ignition engine, wherein it has means to inject dual fuels with different spray angles at different injection timings, preferably with a second type of fuel being injected in smaller spray angles for earlier injections which is away from engine top dead center (TDC), and at least one fuel injection with a first type of fuel which has better ignition quality than the second type of fuel being injected around TDC, and one optional late injection which is away from TDC with second type of fuel.

STATEMENT B: Referring to FIG. 5, a variable orifice fuel injector, comprising of,

(i) a nozzle body (3) comprising passages for fuels, an inner cylindrical bore (307) for receiving two longitudinally displaceable coaxial inward opening needle valves (1, 2) with an inner inward opening needle valve being hold within an outer outward opening needle valve, at least one group of fuel injection outlets (301, 309) in the nozzle body, at least one spring (5, 5′) which urges the needle valves (1, 2) into biased seating positions to block fuels, and a valve block (8) to hold control valves and having fuel inlets which can be connected to two pressured fuel reservoirs (13, 15′), pressure control chambers (382, 125) which can press and release needle valves through applying pressurized and de-pressurized fuels, and

(ii) the inner inward opening needle valve (1), which has an opening position by moving toward nozzle body large end (306) to inject fuel from at least one pressurized reservoir (15′) through one inner fuel injection outlets (208) and another group of outer fuel injection outlets (301), and a biased seating position to block fuel flow, and

(iii) the outer inward opening needle valve (2), which is fully contained in the the nozzle body (3), has an opening position by moving toward nozzle body large end to connect at least one pressurized fuel reservoir (13) and fuel injection outlets (309, 301) to inject fuel, has a biased seating position with its sealing surface (201) being in contact with the sealing surface of nozzle body to block fuel flow, the sealing surface (201) at seating position is up stream of injection outlets (309), wherein the lifting of outer opening needle valve (2) is independent of the position of the inner inward opening needle valve (1);

(iv) the outer inward opening needle valve (2) has an inner seat (202) for the inner inward opening needle valve (1), the inner needle valve (1) is fully contained in outer needle valve (2), wherein the lifting of inner inward opening needle valve (1) is independent of the position of the outer inward opening needle valve (2);

Wherein, the variable orifice fuel injector has means to inject different fuels independently and collectively.

A fuel injector of STATEMENT B, wherein the activation of the inner inward opening needle valve is in a manner similar to passive actuation to reach injection state wherein the pulsed high fuel pressure being supplied to pressure chamber (122) conquers the downward spring force of closing spring (5), wherein the chamber on top of the inner needle valve is at venting pressure;

A fuel injector of STATEMENT B, wherein the activation of the inner inward opening needle valve is in a manner similar to a common rail injector wherein the fuel pressure supplied to pressure chamber (122) equals to fuel pressure supplied to the control chamber (125) on top of the inner needle valve during no-injection status, wherein the fuel pressure in the control chamber (125) on top of the inner needle valve is vented to allow the inner needle valve to be lifted up for fuel injection;

1. A variable orifice fuel injector comprising:
(i) a nozzle body (3) comprising passages for fuels, an inner cylindrical bore (307) for receiving two longitudinally displaceable coaxial needle valves (1, 2), one is outward opening needle valve (1) and another is inward opening needle valve (2), at least one group of fuel injection outlets (301, 309) in said nozzle body, at least one spring (5, 5′) which urges said needle valves (1, 2) into biased seating positions to block fuels, and a valve block (8) to hold control valves and having fuel inlets which can be connected to two pressured fuel reservoirs (12, 13), pressure control chambers (382, 125) which can press and release needle valves through connecting to pressurized and de-pressurized fuels, and
(ii) said outward opening needle valve (1), has an opening position which is moving away relative to said nozzle body large end (306) to inject fuel from at least one pressurized fuel reservoir through an annular fuel outlet (121) and fuel injection outlets (301), and a seating position to block fuel flow, and
(iii) said inward opening needle valve (2), which is fully contained in the said nozzle body (3), has an opening position by moving toward said nozzle body large end (306) to connects at least one pressurized fuel reservoir (13) and fuel injection outlets (309, 301) to inject fuel, wherein the lifting of said inward opening needle valve (2) is independent of the position of said outward opening needle valve (1), and, has a seating position being in contact with the sealing surface of nozzle body to block fuel flow from fuel inlets to fuel injection outlets (309), a sealing surface (201) at seating position is up stream of injection outlets (309), and
(iv) said outward opening needle valve (1) is partially contained in said inward opening needle valve (2) and has a biased siting position on said inward opening needle valve (2), wherein the lifting of outward opening needle valve (1) is independent of the position of said inward opening needle valve (2);
Wherein, said variable orifice fuel injector has means to inject different fuels independently and collectively.

2. A fuel injector of claim 1, wherein it is comprising at least two control valves (9, 10) to block or connect at least one type of fuel from high pressure fuel reservoirs (13, 12, 15′) to low pressure fuel sink (15) to produce the lifting and closing forces on said inward opening and outward opening needle valves (1, 2) through generating pressure differences in pressure control chambers (382, 125).

3. A fuel injector of claim 1, wherein said outward opening needle valve (1) is longitudinally displaceable and partially contained within said inward opening needle valve (2) and guided by a needle guide (104) which is longitudinally displaceable in the inner bore of said inward opening valve (2), wherein said needle valve (1) is at a biased closing position, or at an opening position through pushing the top surface of said outward opening needle valve with pulse pressured fuel to force said needle valve (1) moving outward to inject fuel through one group of fuel injection outlets (301).

4. A fuel injector of claim 1, wherein said inward opening needle valve (2) has a cylindrical space to hold spring (5), said outward opening needle valve (1) and a clip (6), wherein said inward opening needle valve (2) is further comprising fuel passages (122), and a seal cap (7) to define the needle lift, and thrusting surfaces (203, 204) and pressure control chamber (382) to generating lifting force to lift the needle to inject fuel in multiple jets through fuel outlets (301, 309).

5. A fuel injector of claim 1, wherein the half fuel spray angle for one group of fuel injection outlets (a1) and half spray angle for another group of fuel injection outlets (a2) can be same or different, wherein with preferred embodiment such that al is greater than a2.

6. A fuel injector of claim 5, wherein the individual fuel outlets can have the same or different flow area, even within the same group.

7. A fuel injector according to any claim of 1 to 5, wherein it has means to inject one type of fuel through fuel injection outlets (301) by lifting said outward opening needle valve (1) and inject another type of fuel through multiple jet fuel outlets (309) by lifting said inward opening needle valve (2) independently, wherein the injections of two types of fuels can be independently or simultaneously.

8. A fuel injector according to any claim of 1 to 5, wherein it has means to inject the same fuel with different pressures through fuel injection outlets (301) controlled by said outward opening needle valve (1) and another group of fuel outlets (309) controlled by said inward opening needle valve (2), preferably with low pressure fuel being supplied to said fuel injection outlets (309) with smaller spray angles and high pressure fuel being supplied to said multiple jet fuel outlets (301) with larger spray angles, wherein the pressurized fuels in fuel reservoirs are of same molecular structure.

9. An internal combustion engine using at least one fuel injector of claim 1-8, which can be a spark—ignition engine or a compression-ignition engine, wherein it has means to inject dual fuels with different spray angles at different injection timings, preferably with a second type of fuel being injected in smaller spray angles for earlier injections which is away from engine top dead center (TDC), and at least one main fuel injection with a first type of fuel which has better ignition quality than the second type of fuel being injected around TDC, and one optional late injection which is away from TDC with second type of fuel.

10. A variable orifice fuel injector, comprising of,
(i) a nozzle body (3) comprising passages for fuels, an inner cylindrical bore (307) for receiving two longitudinally displaceable coaxial inward opening needle valves (1, 2) with an inner inward opening needle valve being hold within an outer outward opening needle valve, at least one group of fuel injection outlets (301, 309) in said nozzle body, at least one spring (5, 5′) which urges said needle valves (1,2) into biased seating positions to block fuels, and a valve block (8) to hold control valves and having fuel inlets which can be connected to two pressured fuel reservoirs (13, 15′), pressure control chambers (382, 125) which can press and release needle valves through applying pressurized and de-pressurized fuels, and
(ii) said inner inward opening needle valve (1), which has an opening position by moving toward nozzle body large end (306) to inject fuel from at least one pressurized reservoir (15′) through one inner fuel injection outlets (208) and another group of outer fuel injection outlets (301), and a biased seating position to block fuel flow, and
(iii) said outer inward opening needle valve (2), which is fully contained in the said nozzle body (3), has an opening position by moving toward nozzle body large end to connect at least one pressurized fuel reservoir (13) and fuel injection outlets (309, 301) to inject fuel, has a biased seating position with its sealing surface (201) being in contact with the sealing surface of nozzle body to block fuel flow, said sealing surface (201) at seating position is up stream of injection outlets (309), wherein the lifting of outer opening needle valve (2) is independent of the position of said inner inward opening needle valve (1);
(iv) said outer inward opening needle valve (2) has an inner seat (202) for said inner inward opening needle valve (1), said inner needle valve (1) is fully contained in said outer needle valve (2), wherein the lifting of inner inward opening needle valve (1) is independent of the position of said outer inward opening needle valve (2);
Where in, said variable orifice fuel injector has means to inject different fuels independently and collectively.

11. A fuel injector of claim 10, wherein the activation of the said inner inward opening needle valve is in a manner similar to passive actuation to reach injection state wherein the pulsed high fuel pressure being supplied to pressure chamber (122) conquers the downward spring force of closing spring (5), wherein the chamber on top of the said needle valve is at venting pressure.

12. A fuel injector of claim 10, wherein the activation of the said small inward opening needle valve is in a manner similar to a common rail injector wherein the fuel pressure supplied to pressure chamber (122) equals to fuel pressure supplied to the control chamber (125) on top of the said inner needle valve during no-injection status, wherein the fuel pressure in the control chamber (125) on top of the said inner needle valve is vented to allow the said inner needle valve to be lifted up for fuel injection.
